(19) United States
(12) Patent Application Publication
(10) Pub. No.: US 2002/0172438 A1
(43) Pub. Date: Nov. 21, 2002

(54) Bearing apparatus and method for manufacturing same

(75) Inventors: Hisaya Nakagawa, Nagano (JP); Yasushi Mizusaki, Nagano (JP); Masao Takemura, Nagano (JP)

Correspondence Address: SUGHRUE MION, PLLC, 2100 PENNSYLVANIA AVENUE, N.W., WASHINGTON, DC, 20037, US

(73) Assignee: KABUSHIKI KAISHA SANKYO SEIKI SEISAKUSHO

(21) Appl. No.: 10/144,868

(22) Filed: May 15, 2002

(30) Foreign Application Priority Data
May 16, 2001 (JP) P2001-146009

(51) Int. Cl. F16C 32/06

(52) U.S. Cl. 384/107

(57) ABSTRACT

The bearing apparatus used in the motor comprises a rotary shaft, a cylindrical-shaped radial bearing, and a thrust bearing for supporting the lower end portion of the rotary shaft. The rotary shaft is composed of a pipe made of stainless steel and a resin member for closing the lower end portion of the pipe. A groove for generation of dynamic pressure is not formed in the inner peripheral surface of the radial bearing or in the inner peripheral surface of the rotary shaft either. On the upper end portion of the rotary shaft, there is mounted a fan which, due to the rotation of the rotary shaft, takes in the air into the rotary shaft and, in the peripheral surface of the rotary shaft, there are formed blow-out holes for blowing out the air taken in by the fan from the outer peripheral surface of the rotary shaft.

The present application is based on Japanese Patent Application No. 2001-146009, which is incorporated herein by reference.

### BACKGROUND OF THE INVENTION

1. Field of the Invention

The present invention relates to a bearing apparatus for use in a motor.

2. Related Art

As a bearing apparatus which is used in a motor, generally, there is known a bearing apparatus which comprises a rotary shaft and a bearing and also in which one of the rotary shaft and bearing is worked so as to form a groove for generation of dynamic pressure. For example, a motor 1D shown in FIG. 4 comprises a cup-shaped rotor 2 with a drive magnet 21 mounted on the inner peripheral surface thereof, a stator 3 with a drive coil 31 mounted on the outer peripheral surface thereof, and a bearing apparatus 4D for supporting the cup-shaped rotor 2 placed on the stator 3 in such a manner that the cup-shaped rotor 2 can be rotated. In the outer peripheral surface of the cup-shaped rotor 2, there is formed a placement surface on which a polygon mirror 23 can be placed, while the stator 3 is mounted on a mounting plate 32.

The bearing apparatus 4D comprises a cylindrical-shaped rotary shaft 6D extending downward perpendicularly from the center of a top plate 22 of the cup-shaped rotor 2, a cylindrical-shaped radial bearing 5D standing erect up from the center of the stator 3 for supporting the rotary shaft 6D in the radial direction thereof, and a thrust bearing 7D for supporting the lower end portion of the rotary shaft 6D; and, in case where the rotary shaft 6D is fitted with the inner peripheral surface 51D of the radial bearing SD, the cup-shaped rotor 2 placed on the stator 3 can be supported rotatably.

The radial bearing SD is an aerodynamic bearing in which a groove 52 such as a herringbone for generation of dynamic pressure is formed in the inner peripheral surface 51D by cutting the same; and, the radial bearing SD can be formed according to a powder metallurgical method using not only copper-system material such as bronze, brass, phosphor bronze, and nickel silver but also solid lubricants such as molybdenum disulfide, graphite, tungsten disulfide, and boron nitride. For example, the radial bearing SD can be formed in combination of bronze and molybdenum disulfide, or phosphor bronze and graphite, or phosphor bronze and molybdenum disulfide, or phosphor bronze and graphite.

On the other hand, the rotary shaft 6D can be formed by machine working or powder-metallurgy treating a rod member made of austenitic stainless steel such as SUS303, SUS304, or SUS316.

However, in the conventional motor 1D using the aerodynamic bearing, generally, since the shaft diameter of the rotary shaft 6D is thick, for example, 10 mm, the rotary shaft 6D, which is conventionally composed of a rod member made of stainless steel, is excessively heavy in weight; and, therefore, there still remain the following problems to be solved.

That is, firstly, because the rotary shaft 6D is excessively heavy in weight, the load of the rotary shaft 6D to be applied to the radial bearing 5D is large and thus the dynamic pressure to be generated by the radial bearing SD is not sufficient to be able to stand the eccentric load of the rotor 2. Also, the excessively heavy weight of the rotary shaft 6D gives rise to frequent occurrence of metal contact between the rotary shaft 6D and radial bearing SD. Since the load to be applied to the thrust bearing 7D is also large, the thrust bearing 7D wears heavily, which gives rise to the shortened life of the motor 1D. Further, since the rotary shaft 6D is heavy and is made of austenitic material which is soft, during delivery of the motors 1D, the rotary shafts 6D can be butted against each other so that there can occur easily damage such as butting marks on the surfaces of the rotary shafts 6D; and, such damage can lower the dynamic pressure performance of the rotary shafts 6D. Still further, because a thick rod member is used for the rotary shaft 6D, the cost of the material of the rotary shaft 6D is high.

### SUMMARY OF THE INVENTION

The present invention aims at eliminating the drawbacks found in the conventional bearing apparatus. Accordingly, it is an object of the invention to provide a bearing apparatus which can reduce the weight of the rotary shaft thereof to thereby be able not only to enhance the bearing performance of the bearing apparatus but also to reduce the cost of the bearing apparatus.

In attaining the above object, according to the invention, there is provided a bearing apparatus comprising:

a rotary shaft having a hollow cylindrical body, a lower end portion of the rotary shaft being at least partially closed;

a cylindrical-shaped radial bearing for supporting the rotary shaft rotatably;

an air layer generating device for generating an air layer between an outer peripheral surface of the rotary shaft and an inner peripheral surface of the radial bearing to keep the rotary shaft from contacting with the cylindrical-shaped radial bearing by a rotation of the rotary shaft in a steady-state rotating operation of the rotary shaft; and

a thrust bearing disposed on the lower end portion of the rotary shaft for receiving the lower end portion of the rotary shaft.

According to the invention, since the rotary shaft is composed of a hollow cylindrical-shaped body, even in case where the outside diameter of the rotary shaft is large, the weight of the rotary shaft is light and thus the load of the rotary shaft to be applied to the radial bearing is also small. Therefore, even in case where the pressure of the air layer generated by the air layer generating device is small, the eccentric load of a rotor can be supported sufficiently. Also, because the load to be applied to the thrust bearing is also small and thus the wear of the thrust bearing is little, the life of the present bearing apparatus and thus the life of a motor using such bearing apparatus can be extended. Further, due to the light weight of the rotary shaft, in the delivery of motors, even in case the rotary shafts thereof are butted against each other, damage such as butting marks is hard to occur on the surfaces of the rotary shafts, which can prevent the lowered rotational performance of the rotary shafts. Still further, when compared with a rotary shaft which is composed of a rod member, the material cost of the rotary shaft can be reduced and this cost reduction effect can be enhanced as the outside diameter of the rotary shaft increases.

According to the invention, the air layer generating device may include a dynamic pressure generating groove formed in at least one of the inner peripheral surface of the radial bearing and the outer peripheral surface of the rotary shaft.

Also, according to the invention, the air layer generating device may also a fan disposed on an upper end portion of the rotary shaft for taking an air in the rotary shaft by a rotation of the rotary shaft, and a plurality of blow-out holes for blowing out the air taken in by the fan from the outer peripheral surface of the rotary shaft. In this structure, in case where the rotary shaft is rotated, the air is taken into the interior portion of the rotary shaft by the fan disposed on the upper end portion of the rotary shaft, and the air taken in by the fan is blown out from the blow-out holes formed in the peripheral surface of the rotary shaft. Therefore, in the steady-state rotating operation of the rotary shaft, an air layer is generated between the outer peripheral surface of the rotary shaft and the inner peripheral surface of the radial bearing and, due to the pressure of the air layer, the outer peripheral surface of the rotary shaft and the inner peripheral surface of the radial bearing are kept not in contact with each other. Accordingly, a dynamic pressure generating groove need not be formed in the inner peripheral surface of the radial bearing or in the outer peripheral surface of the rotary shaft either. This eliminates the need to enforce machine working or etching, which is necessary to form the dynamic pressure generating groove, on the inner peripheral surface of the radial bearing or on the outer peripheral surface of the rotary shaft, thereby being able to reduce the manufacturing cost of the bearing apparatus. Also, according to this structure, the number and size of the blow-out holes can be changed. Further, differently from the structure in which there is formed a groove for generation of dynamic pressure, since there is no possibility that negative pressure can be generated, the rotary shaft can be prevented against vibration.

In the present invention, there is a case in which the rotary shaft is formed by press working so as to have a bottomed cylindrical shape. In this case, the thrust bearing is structured so as to receive the bottom portion of the bottomed cylindrical-shaped rotary shaft.

Also, in the present invention, there is a case in which, as the rotary shaft, there is used a cylindrical-shaped rotary shaft with the two ends thereof opened and including a resin member mounted on the lower end portion thereof. In this case, the thrust bearing is formed so as to receive the resin member mounted on the lower end portion of the cylindrical-shaped rotary shaft.

In the invention, the rotary shaft, preferably, may be composed of a pipe made of stainless steel. In this case, as the pipe of this type, various pipes are available on the market; and, therefore, pipes on sale can be used as they are. This can reduce the manufacturing cost of the bearing apparatus.

According to the invention, in the interior portion of the rotary shaft, there may be disposed a weight for adjusting the weight balance of the rotary shaft or the axial-direction weight balance of a rotor connected to the rotary shaft. Provision of such weight can lower the gravity positions of the rotary shaft and rotor, so that the rotation performance of the rotary shaft and rotor can be enhanced.

In a method for manufacturing a bearing apparatus to which the invention is applied, when handling the rotary shaft, preferably, the inner surface of the rotary shaft may be held. In other words, the invention provides a method for manufacturing a bearing apparatus comprising the steps of:

providing rotary shaft having a hollow cylindrical body;

providing a cylindrical-shaped radial bearing for

supporting the rotary shaft rotatably;

supporting the rotary shaft by holding an inner surface of the rotary shaft and conducting a working on an outer peripheral surface of the rotary shaft; and

fitting the rotary shaft into an inner peripheral surface of the radial bearing.

In order to enhance the slidability and wear resistance thereof, a film of TiN (titanium nitride) or CrN (chromium nitride) may be formed by ion plating such as PVD on the outer peripheral surface of the rotary shaft.

In a conventional bearing apparatus manufacturing method, in the case of a rotary shaft which is composed of a round rod, when handling the rotary shaft, the outer peripheral surface of the rotary shaft is to be held, which makes it difficult to enforce a surface treatment on the whole of the outer peripheral surface of the rotary shaft. However, according to the invention, since the rotary shaft is formed hollow and thus the inner surface of the rotary shaft can be held, a surface treatment can be carried out on the entire outer peripheral surface of the rotary shaft. Also, because the rotary shaft is formed hollow and thus the inner surface of the rotary shaft can be held, even when enforcing machine working on the rotary shaft, there is no fear that the outer peripheral surface of the rotary shaft can be damaged by chucking.

### BRIEF DESCRIPTION OF THE DRAWINGS

FIG. 1 is a longitudinal section view of a motor using a bearing apparatus according to an embodiment 1 of the invention, wherein the upper part of the figure shows a plan view of a rotary shaft of the motor;

FIG. 2 is a longitudinal section view of a motor using a bearing apparatus according to an embodiment 2 of the invention, wherein the upper part of the figure shows a plan view of a rotary shaft of the motor;

FIG. 3 is a longitudinal section view of a motor using a bearing apparatus according to another embodiment of the invention, wherein the upper part of the figure shows a plan view of a rotary shaft of the motor; and,

FIG. 4 is a longitudinal section view of a motor using a conventional bearing apparatus, wherein the upper part of the figure shows a plan view of a rotary shaft of the motor.

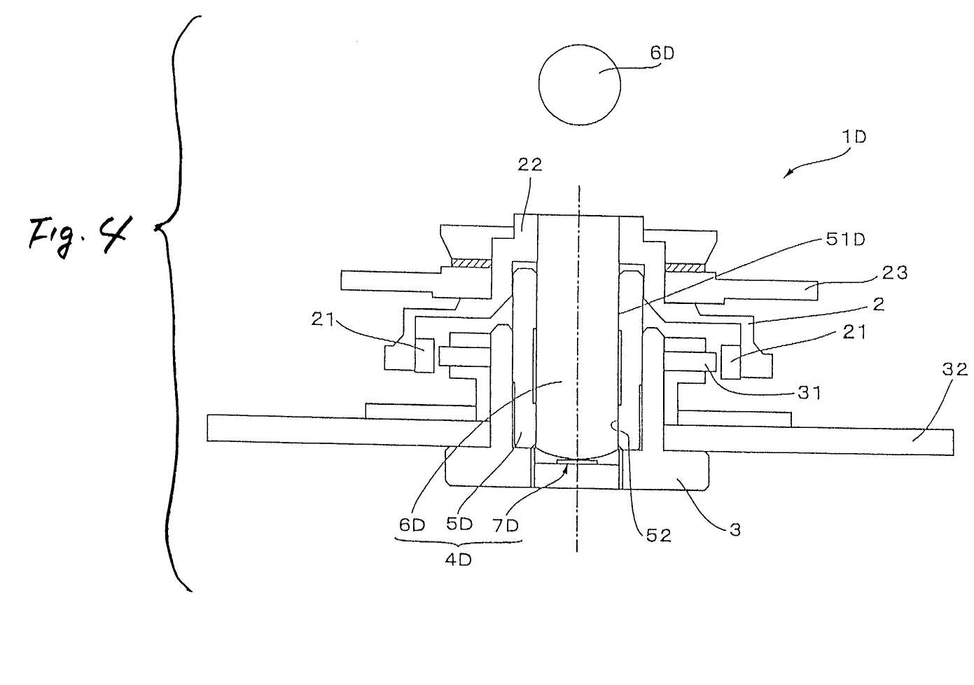

### DETAILED DESCRIPTION OF THE PREFERRED EMBODIMENTS

Now, description will be given below of the preferred embodiments of a bearing apparatus according to the invention with reference to the accompanying drawings.

(Embodiment 1)

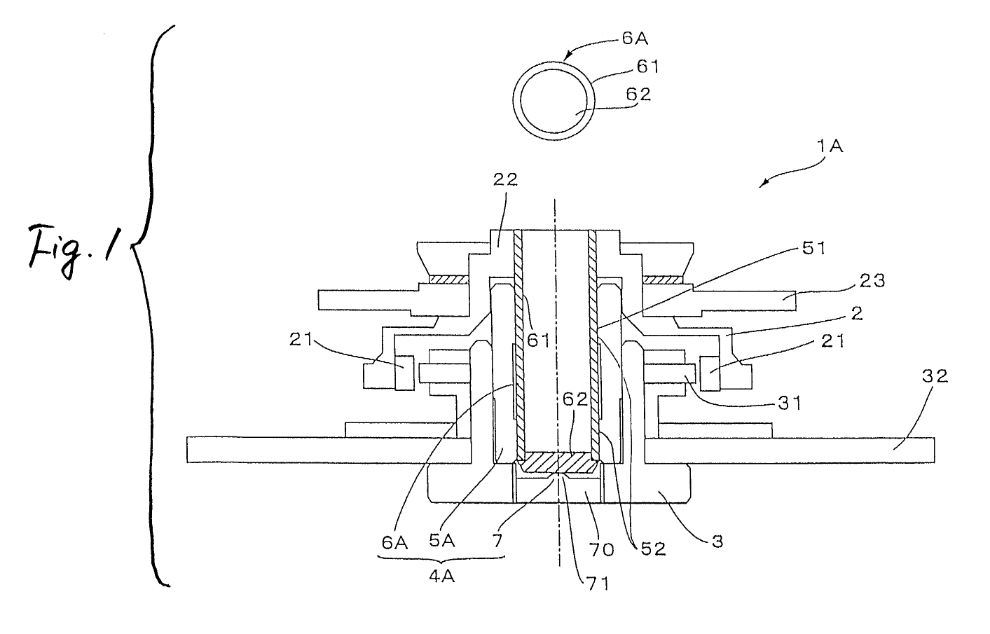

FIG. 1 is a longitudinal section view of a motor using a bearing apparatus to which the invention is applied. The upper portion of the figure shows a plan view of a rotary shaft of the motor.

As shown in FIG. 1, the present motor 1A is a polygon mirror driving motor of an outer rotor type which can be incorporated into a laser beam printer; and, the motor 1A comprises a cup-shaped rotor 2 with a drive magnet 21 mounted on the inner peripheral surface thereof, a stator 3 with a drive coil 31 mounted on the outer peripheral surface thereof, and a bearing apparatus 4A for supporting the cup-shaped rotor 2 placed on the stator 2 in such a manner that the cup-shaped rotor 2 can be rotated. In the outer peripheral surface of the cup-shaped rotor 2, there is formed a placement surface on which a polygon mirror 23 can be placed, while the stator 3 is mounted on a mounting plate 32.

The bearing apparatus 4A comprises a cylindrical-shaped rotary shaft 6A extending downward perpendicularly from the center of a top plate 22 of the cup-shaped rotor 2, a cylindrical-shaped radial bearing 5A standing up erect from the center of the stator 3 for supporting the rotary shaft 6A in the radial direction thereof, and a thrust bearing 7 for supporting the lower end portion of the rotary shaft 6A; and, in case where the rotary shaft 6A is fitted with the inner peripheral surface 51 of the radial bearing 5A, the cup-shaped rotor 2 placed on the stator 3 can be supported rotatably.

The radial bearing 5A is an aerodynamic bearing in which a groove 52 such as a herringbone for generation of dynamic pressure is formed in the inner peripheral surface 51 thereof by cutting the same; and, the groove 52 functions as an air layer generating device which, in the steady-state rotating operation of the rotary shaft 6A, is able to generate an air layer between the outer peripheral surface of the rotary shaft 6A and the inner peripheral surface of the radial bearing 5A due to the rotation of the rotary shaft 6A to thereby keep them not in contact with each other.

The radial bearing 5A can be formed according to a powder metallurgical method using not only copper-system material such as Cu—Sn (bronze), Cu—Zn (brass), Cu—Sn—P (phosphor bronze), and Cu—Ni—Zn (nickel silver) but also solid lubricating material such as MOS₂ (molybdenum disulfide), C (graphite), WS₂ (tungsten disulfide), and BN (boron nitride). That is, to form the radial bearing 5A, for example, bronze and molybdenum disulfide, or phosphor bronze and graphite, or phosphor bronze and molybdenum disulfide, or phosphor bronze and graphite may be combined together. Then, such combined material may be sintered in the temperature range of 650° C. to 750° C. and in an ammonia cracked gas atmosphere. In this case, the compounding ratio of the solid lubricating material is in the range of 1-20%, the formation density of the radial bearing SA is 75%-95% with respect to the true density thereof, and the rate of heat expansion is 16−20×10⁻⁶/° C. In the case of the above-mentioned powder metallurgical method, the manufacturing cost of the radial bearing can be reduced when compared with a cut-out method.

In the present embodiment, the groove 52 can be formed by molding in the powder metallurgical process of the radial bearing 5A or in the sizing process thereof; and, the inside diameter shape of the radial bearing SA may be a step shape, a taper shape, a multi-lobular shape, or a taper flat shape.

By the way, when manufacturing the radial bearing 5A according to the powder metallurgical method, there must be carried out a material mixing step, a molding step, a sintering step, a rust preventing step, a sizing step (a re-compressing step), a cleaning step, and a rust preventing step.

On the other hand, the rotary shaft 6A is composed of a circular-shaped pipe 61 which is formed of austenitic stainless steel such as SUS303, SUS304, or SUS316 and has an outside diameter of 8 φ or more and a thickness of 2 mm or less, while the rotary shaft 6Ais formed hollow. For example, for the rotary shaft 6A, there is used a pipe 61 having an outside diameter of 10 φ and a thickness of 1 mm, and the rate of heat expansion thereof is 16−17×10⁻⁶/° C. Also, on the lower end portion of the pipe 61, there is mounted a resin member 62 for closing the lower end opening of the pipe 61. And, the thrust bearing 7 is able to support the lower end portion 6A projected upwardly from a disk 70 which is fixed to the stator 3 at a position just below the rotary shaft 6A.

The thrust bearing 7 may also be structured such that a pivot is disposed on the resin member 62 side and the pivot is received by a disk. Also, instead of the resin member 62, a hard ball may be fitted into the lower end portion of the pipe 61 to thereby form the thrust bearing 7. In either of these structures, in case where the resin member 62 or hard ball is pressure inserted so as not to stick out from the lower end portion of the pipe 61, the thrust bearing 7 can be formed while the longitudinal dimension of the rotary shaft 6A remains short.

On the outer peripheral surface of the rotary shaft 6A, in order to enhance the slidability and wear resistance thereof, a film of TiN (titanium nitride) or CrN (chromium nitride) may be formed by ion plating such as PVD. In this case, since the rotary shaft 6A is hollow, in case where the inside of the rotary shaft 6A is held, a surface treatment can be executed on the entire outer peripheral surface of the rotary shaft 6A.

Also, in case where martensitic stainless steel is used as the material of the pipe 61, resin having a large rate of heat expansion may be filled into the interior portion of the pipe 61 to thereby match the rate of heat expansion of the rotary shaft 6A to the rate of heat expansion of the radial bearing 5A.

By the way, to manufacture the rotary shaft 6A, after a pipe (fused product) is cut to a given length, the given-length pipe is worked by cutting and, next, there are enforced a centerless grinding step, a barrel step, a cleaning step and a rust preventing step on the given-length pipe. Also, in case where the rotary shaft 6A is manufactured according to a powder metallurgical method, there are enforced a material mixing step, a molding step, a sintering step, a rust preventing step, a centerless grinding step, a barrel step, a cleaning step and a rust preventing step.

According to the thus structured motor 1A, in the bearing apparatus 4A, since the rotary shaft 6A is composed of a hollow cylindrical member, even in case where the outside diameter of the rotary shaft 6A is large, the weight thereof is light. Therefore, the load of the rotary shaft 6A to be applied to the radial bearing 5A is small and thus, even in case where the pressure of an air layer generated by the groove 52 for generation of aerodynamic pressure is small, the eccentric load of the rotor 2 can be supported sufficiently. Also, because the rotary shaft 6A is light, metal contact is hard to occur frequently between the rotary shaft 6A and radial bearing SA. Further, since the load to be applied to the thrust bearing 7 is also small, the wear of the thrust bearing 7 is little, which can extend the life of the bearing apparatus 4A and thus the life of the motor 1A using the bearing apparatus 4A. Still further, because of the light weight of the rotary shaft 6A, during the delivery of the motors 1A, even in case where the rotary shafts 6A thereof are butted against each other, damage such as butting marks is hard to occur on the surfaces of the rotary shafts 6A, which can prevent the lowered rotation performance of the rotary shafts 6A. And, when compared with a rotary shaft 6A composed of a rod member, the material cost of the present rotary shaft 6A can be reduced and this cost reducing effect becomes large as the outside diameter of the rotary shaft 6A increases.

Also, as the rotary shaft 6A, there is used a pipe (fused product) made of stainless steel. In the case of this pipe, since various kinds of pipes of this type are available on the market, pipes on sale can be used as they are. Therefore, the manufacturing cost of the bearing apparatus 4A can be reduced.

Further, in the manufacturing method of the bearing apparatus 4A, in the case of a rotary shaft which is composed of a round rod member, when holding the rotary shaft, the outer peripheral surface of the rotary shaft is to be held, which makes it difficult to enforce a surface treatment on the whole of the outer peripheral surface of the rotary shaft. However, according to the invention, because the rotary shaft 6A is hollow, the inner surface of the rotary shaft 6A can be held, which makes it possible to enforce a surface treatment on the whole of the outer peripheral surface of the rotary shaft 6A. Also, since the inside of the rotary shaft 6A can be held due to its hollow shape, even when enforcing machine working on the rotary shaft 6A, there is no fear that the outer peripheral surface of the rotary shaft 6A can be damaged by chucking.

Still further, in case where a pipe is used to manufacture the rotary shaft 6A, the pipe-type rotary shaft 6A as it is cannot constitute the thrust bearing 7. However, according to the invention, since the resin member 62 is mounted on the lower end portion of the pipe 61, the thrust bearing 7 is able to receive the rotary shaft 6A through its pivot 71. Also, according to the present embodiment, since the rotary shaft 6A is light and thus the load to be applied to the thrust bearing 7 is small, the thrust bearing 7 having a simple structure using the pivot 71 is able to deal with the load applied thereto. Therefore, the reduced costs of the bearing apparatus 4a and motor 1B can be realized.

(Embodiment 2)

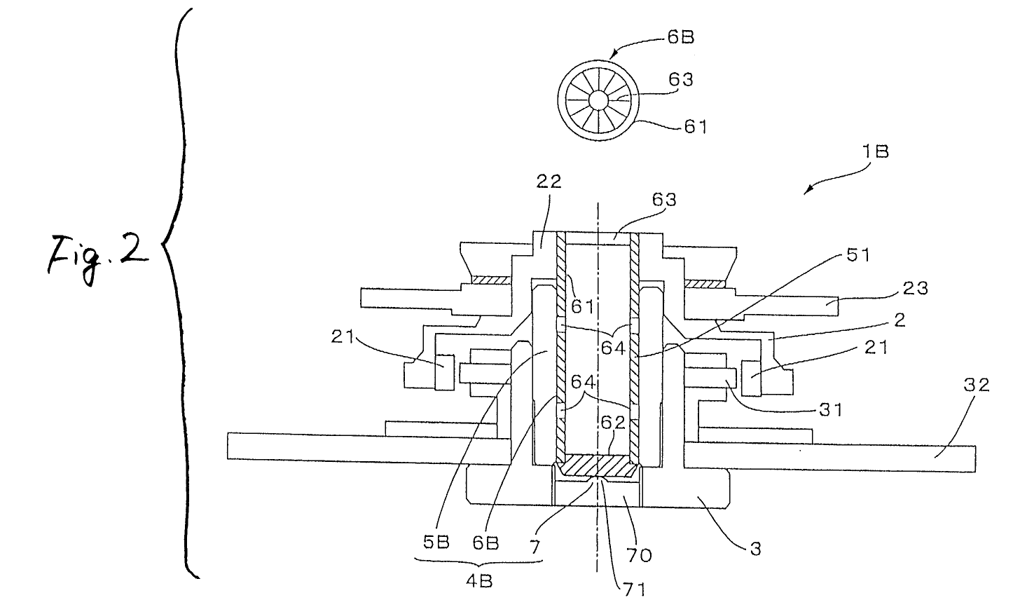

FIG. 2 is a longitudinal section view of a motor using a bearing apparatus to which the invention is applied, The upper part of the figure shows a plan view of a rotary shaft of the motor. By the way, the motor according to the present embodiment is basically similar to the previously described embodiment 1. Therefore, parts used in common are given the same designations and thus the description of the structures of these parts is omitted here.

As shown in FIG. 2, a bearing apparatus 4B used in the motor 1B according to the present embodiment, similarly to the embodiment 1, comprises a cylindrical-shaped rotary shaft 6B extending downward perpendicularly from the center of a top plate 22 of a cup-shaped rotor 2, a cylindrical-shaped radial bearing 5B standing up erect from the center of a stator 3 for supporting the rotary shaft 6B in the radial direction thereof, and a thrust bearing 7 for supporting the lower end portion of the rotary shaft 6B; and, in case where the rotary shaft 6B is fitted with the inner peripheral surface 51 of the radial bearing 5B, the cup-shaped rotor 2 placed on the stator 3 can be supported rotatably.

The radial bearing 5B, similarly to the embodiment 1, can be formed according to a powder metallurgical method using not only copper-system material such as Cu—Sn (bronze), Cu—Zn (brass), Cu—Sn—P (phosphorbronze), and Cu—Ni—Zn (nickel silver) but also solid lubricating material such as MoS₂ (molybdenum disulfide), C (graphite), WS₂ (tungstendisulfide), and BN (boron nitride). That is, to form the radial bearing 5B, for example, bronze and molybdenum disulfide, or phosphor bronze and graphite, or phosphor bronze and molybdenum disulfide, or phosphor bronze and graphite may be combined with each other.

On the other hand, the rotary shaft 6B is composed of a circular pipe 61 which is formed of austenitic stainless steel such as SUS303, SUS304, or SUS316 and has an outside diameter of 8 φ.or more and a thickness of 2 mm or less, while the rotary shaft 6B is hollow. For example, for the rotary shaft 6B, there is used a pipe 61 having an outside diameter of 10 φ.and a thickness of 1 mm, and the rate of heat expansion thereof is 16−17×10⁻⁶/° C. Also, on the lower end portion of the pipe 61, there is mounted a resin member 62 for closing the lower end opening of the pipe 61. And, the thrust bearing 7 is able to support the lower end portion 6B projected upwardly from a disk 70 which is fixed to the stator 3 at a position just below the rotary shaft 6B. Here, the lower end opening of the rotary shaft 6B is completely closed by the resin member 62. By the way, the thrust bearing 7 may be structured such that a pivot is disposed on the resin member 62 side and the pivot is received by a disk. Also, instead of the resin member 62, a hard ball may be fitted into the lower end portion of the pipe 61 to thereby form the thrust bearing 7. In either of these structures, in case where the resin member 62 or hard ball is pressure inserted into the lower end portion of the pipe 61 in such a manner that the resin member 62 or hard ball can be prevented from sticking out from the lower end portion of the pipe 61 as much as possible, the thrust bearing 7 can be structured while the longitudinal dimension of the rotary shaft 6B remains short.

According to the present embodiment, in neither the inner peripheral surface of the radial bearing 5B nor the inner peripheral surface of the rotary shaft 6B, there is formed a groove such as herringbone for generation of dynamic pressure. But, instead, as an air layer generating device for generating an air layer between the outer peripheral surface of the rotary shaft 6B and the inner peripheral surface of the radial bearing 5B in such a manner that, in the steady-state rotating operation of the rotary shaft 6B, the outer peripheral surface of the rotary shaft 6B and the inner peripheral surface of the radial bearing 5B can be kept not in contact with each other, not only on the upper end portion of the rotary shaft 6B, there is mounted a fan 63 which can take in the air into the rotary shaft 6B due to the rotation of the rotary shaft 6B, but also in the peripheral surface of the rotary shaft 6B, there are formed blow-out holes 64 respectively for blowing out the air taken in by the fan 63 from the outer peripheral surface of the rotary shaft 6B. According to the present embodiment, in the rotary shaft 6B, there are formed two rows of blow-out holes 64, each row including five blow-out holes 64, spaced at given intervals in the axial direction of the rotary shaft 6B. Here, the number and size of the blow-out holes 64 can be designed most properly according to the number of rotations.

In the thus structured bearing apparatus 4B, in a state where the rotary shaft 6B is steadily rotating, the air is taken into the rotary shaft 6B by the fan 63 and the air taken in by the fan 63 is blown out from the outer peripheral surface of the rotary shaft 6B toward the inner peripheral surface of the radial bearing 5B; and, due to the pressure of the present air, the outer peripheral surface of the rotary shaft 6B and the inner peripheral surface of the radial bearing 5B can be kept not in contact with each other. Therefore, a groove for generation of dynamic pressure need not be formed in the outer peripheral surface of the rotary shaft 6B or in the inner peripheral surface of the radial bearing 5B either. This eliminates the need to enforce machine working or etching on the outer peripheral surface of the rotary shaft 6B or on the inner peripheral surface of the radial bearing SB for formation of the dynamic pressure generating groove, thereby being able to reduce the manufacturing cost of the bearing apparatus 4B.

Also, the number and size of the blow-out holes 64 can be changed according to the number of rotations. Further, differently from a structure in which there is formed a groove for generation of dynamic pressure, since no negative pressure is generated, the vibration of the rotary shaft is prevented from occurring. Moreover, similarly to the embodiment 1, because the rotary shaft 6B is composed of a hollow cylindrical body, even in case where the outside diameter of the rotary shaft 6B is large, the rotary shaft 6B is light in weight and thus the load of the rotary shaft 6B to be applied to the radial bearing 6B is small. Therefore, similarly to the embodiment 1, according to the present embodiment, there can be obtained an effect that the eccentric load of the rotor 2B can be supported sufficiently.

(Other Embodiments)

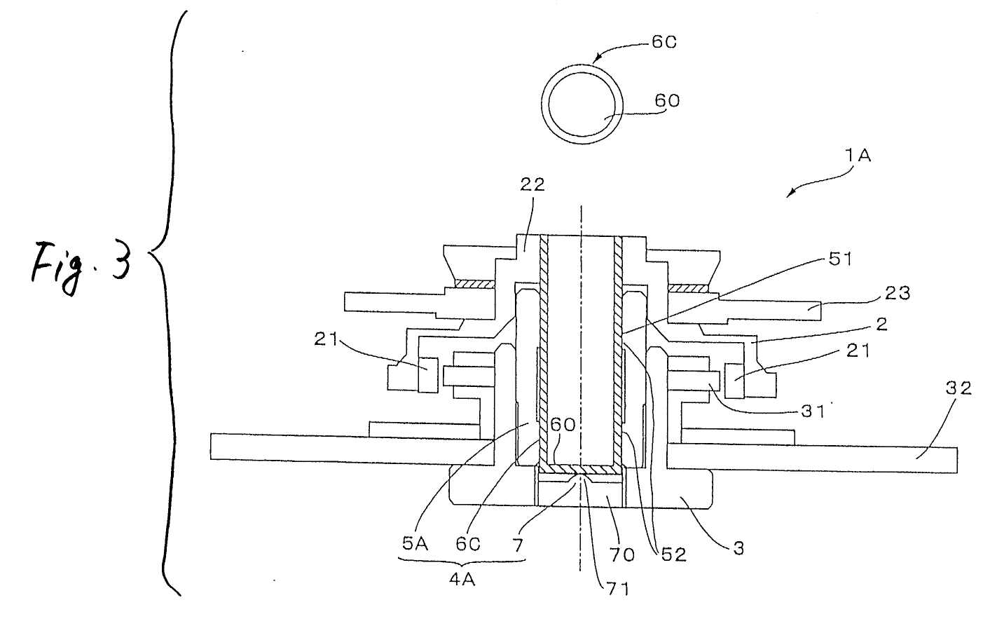

In the embodiments 1 and 2, the stainless-steel-made pipe 61 is used to produce the rotary shaft 6A and 6B. However, as shown in FIG. 3, there may be used a cylindrical-shaped bottomed rotary shaft 6C by press working such as by drawing. In this embodiment, since the lower end portion of the rotary shaft 6C is closed by a bottom portion 60, the pivot 71 of the thrust bearing 7 supports the bottom portion 60 of the rotary shaft 6C. The remaining portions of the present embodiment are similar in structure to the embodiment 1. Therefore, parts used in common are given the same designations and thus the description of the structures thereof is omitted here. By the way, in FIG. 3, there is shown this embodiment in which the embodiment 1 described with reference to FIG. 1 is press worked to thereby form the cylindrical-shaped bottomed rotary shaft 6C. However, alternatively, the embodiment 2 described with reference to FIG. 2 may be press worked to thereby form a cylindrical-shaped bottomed rotary shaft 6C.

Also, in all of the above-illustrated embodiments, since the rotary shafts 6A, 6B and 6C are respectively formed hollow, at the given positions of the interior portions of the rotary shafts 6A, 6B and 6C, there may also be disposed weights for adjusting the weight balance of the rotary shafts 6A, 6B and 6C, or the axial-direction weights of the rotors 2 respectively connected to the rotary shafts 6A, 6B and 6C. This can lower the gravity positions of the rotary shafts 6A, 6B and 6C, and the rotors 2, thereby being able to enhance the rotation performance thereof.

As has been described heretofore, according to the invention, since the rotary shaft is composed of a hollow cylindrical body, even in case where the outside diameter of the rotary shaft is large, the weight of the rotary shaft is light. Therefore, because the load of the rotary shaft to be applied to the radial bearing is small, even in case where the pressure of the air layer generated by the air layer generating device is small, the eccentric load of the rotor can be supported sufficiently. Also, since the rotary shaft is light, metal contact is hard to occur between the rotary shaft and radial bearing. Further, because the load to be applied to the thrust bearing is small and thus the wear of the thrust bearing is little, the life of the bearing apparatus and thus the life of the motor using such bearing apparatus can be extended. Still further, since the rotary shaft is light, in the delivery of the motors, even in case where the rotary shafts thereof are butted against each other, damage such as butting marks is hard to occur in the surfaces of the rotary shafts, which can prevent the lowered rotation performance thereof. In addition, when compared with a case in which the rotary shaft is composed of a rod member, the material cost can be reduced and also the effect of such material cost reduction becomes large as the outside diameter of the rotary shaft increases.

What is claimed is:

1. A bearing apparatus comprising:
a rotary shaft having a hollow cylindrical body, a lower end portion of said rotary shaft being at least partially closed;
a cylindrical-shaped radial bearing for supporting said rotary shaft rotatably;
an air layer generating device for generating an air layer between an outer peripheral surface of said rotary shaft and an inner peripheral surface of said radial bearing to keep said rotary shaft from contacting with said cylindrical-shaped radial bearing by a rotation of said rotary shaft in a steady-state rotating operation of said rotary shaft; and
a thrust bearing disposed on the lower end portion of said rotary shaft for receiving said lower end portion of said rotary shaft.

2. A bearing apparatus according to claim 1, wherein said air layer generating device includes a dynamic pressure generating groove formed in at least one of the inner peripheral surface of said radial bearing and the outer peripheral surface of said rotary shaft.

3. A bearing apparatus according to claim 1, wherein said air layer generating device includes a fan disposed on an upper end portion of said rotary shaft for taking an air in said rotary shaft by a rotation of said rotary shaft, and a plurality of blow-out holes for blowing out said air taken in by said fan from the outer peripheral surface of said rotary shaft.

4. A bearing apparatus according to claim 1, wherein said rotary shaft is formed by press working so as to have a bottomed cylindrical shape, and said thrust bearing receives a bottom portion of said bottomed cylindrical-shaped rotary shaft.

5. A bearing apparatus according to claim 1, wherein said rotary shaft is formed so as to have a cylindrical shape in which both ends thereof have an opening respectively, and said thrust bearing receives a resin member mounted on the lower end portion of said cylindrical-shaped rotary shaft.

6. A bearing apparatus according to claim 1, wherein said rotary shaft is constituted by a pipe made of stainless steel.

7. A bearing apparatus according to claim 1, wherein a weight is disposed inside said rotary shaft for adjusting a weight balance of said rotary shaft or an axial-direction weight balance of a rotor connected to said rotary shaft.

8. A method for manufacturing a bearing apparatus comprising the steps of:
providing rotary shaft having a hollow cylindrical body;
providing a cylindrical-shaped radial bearing for supporting said rotary shaft rotatably;
supporting said rotary shaft by holding an inner surface of said rotary shaft and conducting a working on an outer peripheral surface of said rotary shaft; and
fitting said rotary shaft into an inner peripheral surface of said radial bearing.

9. A method for manufacturing a bearing apparatus according to claim 8,
wherein a surface treatment is conducted on said outer peripheral surface of said rotary shaft while supported by holding an inner surface of said rotary shaft.

10. A method for manufacturing a bearing apparatus according to claim 9, an ion plating is conducted as the surface treatment.
